(19) United States
(12) Patent Application Publication
(10) Pub. No.: US 2007/0021694 A1
(43) Pub. Date: Jan. 25, 2007

(54) Massager for lower limb

(76) Inventor: Satoru Shiraishi, Osaka (JP)

Correspondence Address: BIRCH STEWART KOLASCH & BIRCH, PO BOX 747, FALLS CHURCH, VA, 22040-0747, US

(21) Appl. No.: 10/568,100

(22) PCT Filed: Aug. 26, 2004
(86) PCT No.: PCT/JP04/06014

§ 371 Date: Feb. 13, 2006

(30) Foreign Application Priority Data
Aug. 29, 2003 (JP) 2003-307550

(51) Int. Cl. A61H 7/00

(52) U.S. Cl. 601/94; 601/90; 601/134; 601/DIG. 17

(57) ABSTRACT

A lower leg massager according to the invention is capable of massaging lower legs of a user, and has a structure with reduced size which can be manufactured with reduced costs. The lower leg massager includes a leg-rest 2 provided with a first massaging mechanism 4 disposed therein for massaging each calf of right and left lower legs, a footrest 3 disposed on an end of the leg-rest and provided with a second massaging mechanism 5 disposed therein for massaging each foot of right and left lower legs, and a driving mechanism 10 disposed at an intermediate position in a right and left direction of the leg-rest 2 and/or the footrest 3 for simultaneously driving both of the massage mechanisms 4, 5.

### TECHNICAL FIELD

The present invention relates to a lower leg massager and a chair type massaging apparatus using the same.

### BACKGROUND ART

Hitherto, there has been developed chair type massaging apparatuses that can massage not only the back of the human body but also the lower legs as disclosed in, for example, JP-A-2003-38590.

This chair type massaging apparatus comprises a leg-rest for massaging each calf of both right and left lower legs and a footrest for massaging both feet of both right and left lower legs.

The leg-rest and footrest comprise a pair of right and left insertion recesses for inserting right and left calves and right and left feet, respectively, and airbags on the inner sides of opposing surfaces and bottom surfaces of the pair of right and left insertion recesses. Each airbags are inflated and deflated by an air supplying/discharging apparatus to massage calves and feet inserted in the insertion recesses.

Since the leg-rest and the footrest of this chair type massaging apparatus employs airbags, a compressor, an air piping, an electromagnetic valve, and a control device for controlling the inflation and deflation of the airbags are provided.

Regarding to the control device of the leg-rest and the footrest, particularly, the compressor or the like is disposed outside of the leg-rest and the footrest, for example, under a seat portion on which a user of the chair type massaging apparatus sits, resulting in a disadvantage of increased size of the chair type massaging apparatus. Namely, the sizes of the leg-rest and the footrest are disadvantageously increased.

Moreover, there is another disadvantage of complicating the programming of the control device for controlling the plurality of airbags provided in the leg-rest and the footrest, thereby increasing manufacturing costs.

In view of the above-mentioned disadvantages, it is an object of the present invention to provide a lower leg massager of compact size which can be manufactured at low costs.

### DISCLOSURE OF THE INVENTION

In order to achieve the object described above, the present invention provides the following technical means.

That is, the technical means according to the present invention for solving the problems is characterized by comprising: a leg-rest comprising a first massaging mechanism disposed in the leg-rest and configured to receive and massage each calf of right and left lower legs inserted therein, a footrest disposed on an end of the leg-rest, and comprising a second massaging mechanism disposed in the footrest and configured to receive and massage each foot of the right and the left lower legs inserted therein, and a driving mechanism disposed at an intermediate position in a right and left direction of the leg-rest and/or the footrest for simultaneously-driving both the first massaging mechanism and the second massaging mechanism.

With this arrangement, since the driving mechanism is disposed at an intermediate position in the right and left direction of the leg-rest and/or the footrest to drive both the first massaging mechanism and the second massaging mechanism simultaneously, it is possible to massage both calf and foot simultaneously. Further, the space at the intermediate portion in the right and left direction of the leg-rest and the footrest is effectively utilized, thereby allowing reduction of entire size of the apparatus.

Another technical means according to the present invention for solving the problems is characterized by comprising: a leg-rest comprising a first massaging mechanism disposed in the leg-rest and configured to receive and massage each calf of right and left lower legs fitted therein, a footrest disposed on an end of the leg-rest, and comprising a second massaging mechanism disposed in the footrest and configured to receive and massage each foot of the right and the left lower legs fitted therein, and a driving mechanism disposed at an intermediate position in a right and left direction of the leg-rest and/or the footrest for independently driving the first massaging mechanism and the second massaging mechanism.

With this arrangement, since the driving mechanism is disposed at an intermediate position in the right and left direction of the leg-rest and/or the footrest to drive the first massaging mechanism and the second massaging mechanism independently, it is possible to massage a calf and a foot independently. Further, the space at the intermediate portion in the right and left direction of the leg-rest and the footrest is effectively utilized, thereby allowing reduction of entire size of the apparatus.

Another technical means according to the present invention for solving the problems is characterized in that the first massaging mechanism and the second massaging mechanism are driven by a single driving mechanism.

With this arrangement, since the single driving mechanism drives both of the massaging mechanisms, it is possible to reduce number of parts and manufacturing costs of the apparatus.

Another technical means according to the present invention for solving the problems is characterized in that the driving mechanism comprises a single driving motor disposed between the first massaging mechanism and the second massaging mechanism, in which the driving motor has a driving shaft extending toward the both of the massaging mechanism sides and is connected therewith so as to transmit power.

With this arrangement, it is possible to drive both of the massaging mechanisms by the single motor.

Another technical means according to the present invention for solving the problems is characterized in that the first massaging mechanism, the second massaging mechanism and the driving mechanism are supported by a single supporting body.

With this arrangement, since both of the massaging mechanisms and the driving mechanism are supported by a single supporting body, it is possible to share supporting bodies for supporting each component and to reduce manufacturing costs.

Another technical means according to the present invention for solving the problems is characterized in that the second massaging mechanism comprises a sole massaging mechanism which is driven by the driving mechanism for massaging a sole.

With this arrangement, the sole massaging mechanism massages a sole while the second massaging mechanism massages a foot, thereby allowing the footrest to massage an entire foot.

Further, another technical means according to the present invention for solving the problems is characterized in that the first massaging mechanism comprises a pair of massaging members disposed away from each other in the right and left direction so as to enclose the calf therebetween, a rotation shaft rotated by the driving mechanism, a rotary member fixed to the rotation shaft and relatively rotatably fitted in the massaging member, and a restricting means for restricting a following rotation of the massaging member with respect to the rotary member, in which the rotary member has a sliding surface formed in a cylindrical-shape tilting with respect to the rotation shaft so that the massaging member performs a swing motion.

With this arrangement, the first massaging mechanism for massaging a calf causes the massaging member to swing by rotating the rotation shaft so as to perform massaging operations to a calf. Moreover, since the massaging member is caused to perform massaging operations only by rotating the rotation shaft, the present invention has a more simplified structure than conventional air type massagers, and it is possible to reduce manufacturing costs.

Another technical means according to the present invention for solving the problems is characterized in that the second massaging mechanism comprises a pair of massaging members disposed away from each other in the right and left direction so as to enclose the foot therebetween, a rotation shaft rotated by the driving mechanism, a rotary member fixed to the rotation shaft and relatively rotatably fitted in the massaging member, and a restricting means for restricting a following rotation of the massaging member with respect to the rotary member, in which the rotary member has a sliding surface formed in a cylindrical-shape tilting with respect to the rotation shaft so that the massaging member performs a swing motion.

With this arrangement, the second massaging mechanism for massaging a foot causes the massaging member to swing by rotating the rotation shaft so as to perform massaging operations to a foot. Moreover, since the massaging member is caused to perform massaging operations only by rotating the rotation shaft, the present invention has a more simplified structure than conventional air type massagers and it is possible to reduce manufacturing costs.

Another technical means according to the present invention for solving the problems is characterized in that the leg-rest is formed with a pair of right and left insertion recesses into which calves are inserted, respectively, while the footrest is formed with a pair of right and left insertion recesses into which feet are inserted, respectively, and which are communicated with the insertion recesses of the leg-rest, respectively, and the pair of massaging members of the first massaging mechanism are-disposed on the inside and on the both right and left sides of each insertion recess of the leg-rest.

With this arrangement, it is possible to massage calves entirely by the massaging member of the first massaging mechanism after inserting calves into the pair of right and left insertion recesses formed in the leg-rest and inserting feet into the pair of right and left insertion recesses formed in the footrest.

Further, another technical means according to the present invention for solving the problems is characterized in that the leg-rest is formed with a pair of right and left insertion recesses into which calves are inserted, respectively, while the footrest is formed with a pair of right and left insertion recesses into which feet are inserted, respectively, and which are communicated with the insertion recesses of the leg-rest, respectively, and the pair of massaging members of the second massaging mechanism are disposed on the inside and on the both right and left sides of each insertion recess of the footrest.

With this arrangement, it becomes possible to massage feet entirely by the massaging member of the second massaging mechanism after inserting calves into the pair of right and left insertion recesses formed in the leg-rest and inserting feet into the pair of right and left insertion recesses formed in the footrest.

Preferably, the massaging member of the first massaging mechanism and/or the second massaging mechanism is formed of an elastic body which is elastically deformable in the right and left direction.

With this arrangement, even if the massaging member grasps a calf or a foot strongly, the deformation of the massaging member formed of the elastic body in the right and left direction prevents an excessive force to the calf or the foot.

Another technical means according to the present invention for solving the problems is characterized in that the leg-rest is formed with a pair of right and left insertion recesses into which calves are inserted, respectively, while the footrest is formed with a pair of right and left insertion recesses in which feet are inserted, respectively, and which are communicated with the insertion recesses of the leg-rest, respectively, and the driving mechanism is disposed in a space extending from a space between the pair of insertion recesses formed in the leg-rest to a space between the pair of insertion recesses formed in the footrest.

With this arrangement, since the driving mechanism is disposed in an intermediate portion of the leg-rest and the footrest in the right and left direction, the space between the pair of right and left insertion recesses is effectively utilized, thereby allowing reduction of entire size of the apparatus.

### BRIEF DESCRIPTION OF THE DRAWINGS

FIG. 1 is a plan view of a lower leg massager showing an internal structure thereof;

FIG. 2 is a perspective view of the lower leg massager;

FIG. 3 is a cross sectional view taken along the line X-X in FIG. 1;

FIG. 4 is a cross sectional view taken along the line Y-Y in FIG. 1;

FIG. 5 is a front view of a leg-rest of the lower leg massager;

FIG. 6 is a cross sectional view taken along the line Z-Z in FIG. 5;

FIG. 7 is a front view of a footrest of the lower leg massager;

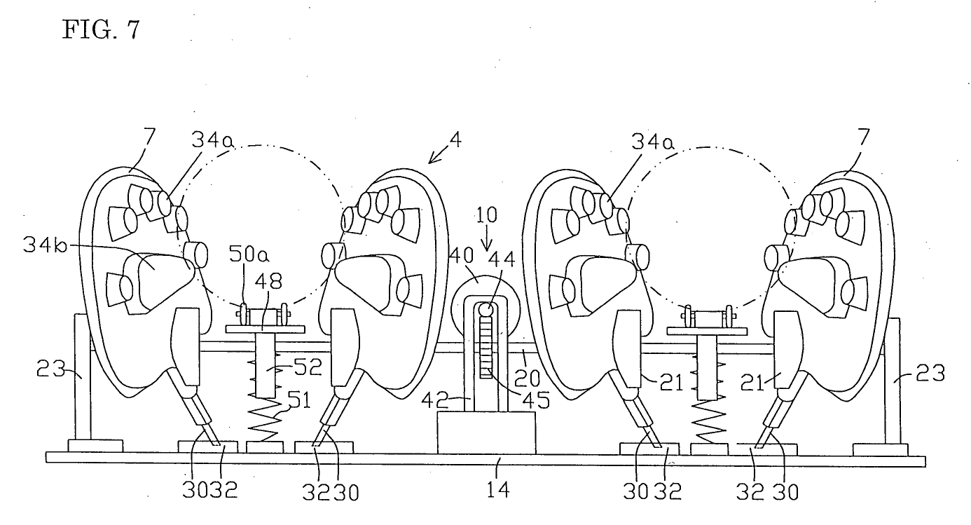

FIG. 8 is a perspective view of a chair type massaging apparatus provided with the lower leg massager;

FIG. 9 is a perspective view of a lower leg massager;

FIG. 10 is a side view of the lower leg massager showing an internal structure;

FIG. 11 is a front view of a lower leg massager showing an internal structure; and

FIG. 12 is a plan view of a first massaging mechanism.

### BEST MODE FOR CARRYING OUT THE INVENTION

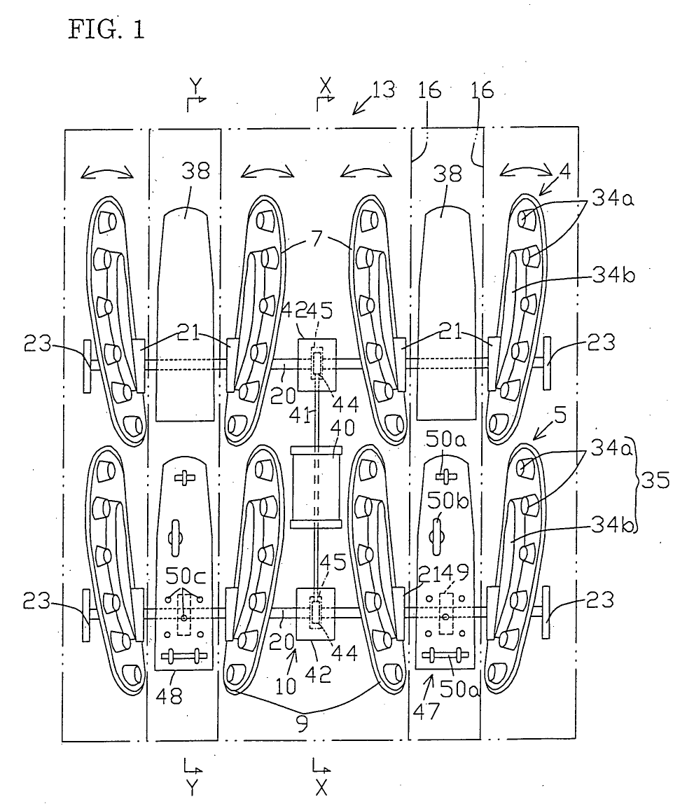

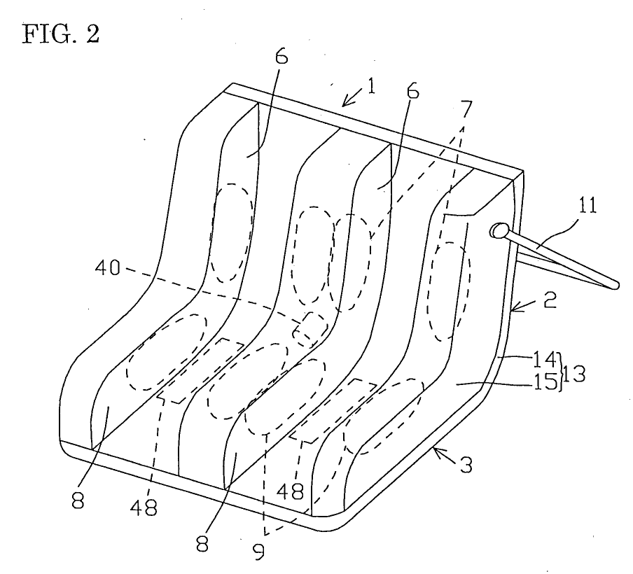

As shown in FIG. 1 and FIG. 2, a lower leg massager according to this embodiment comprises a leg-rest 2 for mounting right and left calves and a footrest 3 disposed on a lower end of this leg-rest 2 for mounting right and left feet.

The leg-rest 2, which massages calves of a human body, comprises leg-rest massaging mechanisms 4 (first massaging mechanisms for massaging calves).

Insertion recesses 6 for inserting right and left calves are provided on a surface of this leg-rest 2, and a pair of right and left massaging members for calves 7 (massaging members provided for the first massaging mechanism), which are separated in the right and left direction so as to enclose a calf, are disposed on the opposing surfaces of the insertion recess 6 of the leg-rest 2.

The footrest 3, which massages feet of a human body, comprises a footrest massaging mechanism 5 (a second massaging mechanism) for massaging both sides of a foot. Insertion recesses 8 for inserting right and left feet are provided on a surface of this footrest 3, and a pair of right and left massaging members for both sides of feet 9 (massaging members provided for the second massaging mechanism), which are separated in the right and left direction so as to enclose both sides of a foot, are disposed on the opposing surfaces of the insertion recess 8 of the footrest 3.

The leg-rest 2 and the footrest 3 are formed integrally in such a manner that the insertion recesses 6, 8 of the leg-rest 2 and the footrest 3 are connected successively so as to rout feet and calves through them, and this lower leg massager 1 is shaped in the form of a letter L in a side view for facilitating insertion of calves or feet.

For a reference, in this specification, explanations are provided after referring that “lower leg” is a portion below a knee of a human leg and the lower leg is separated into “a calf”, which is a portion above an ankle, and “a foot”, which is a portion below the ankle.

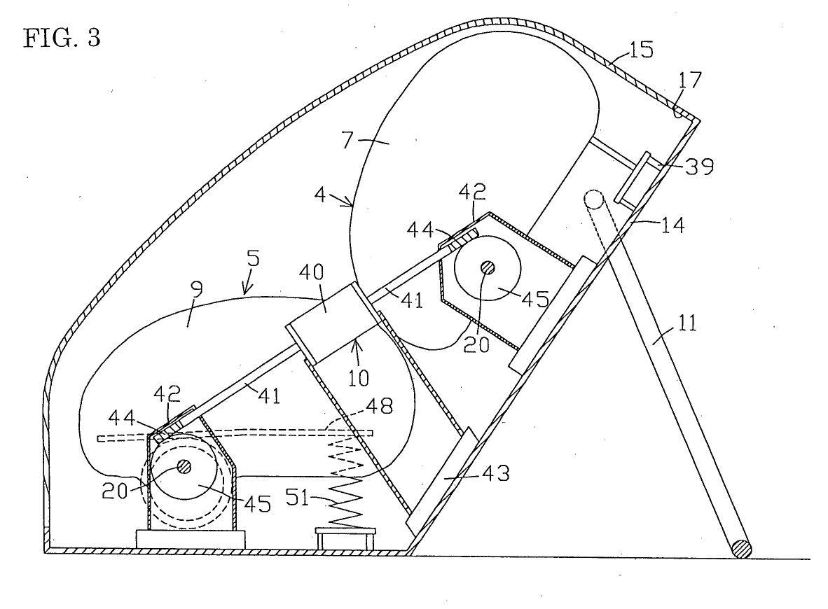

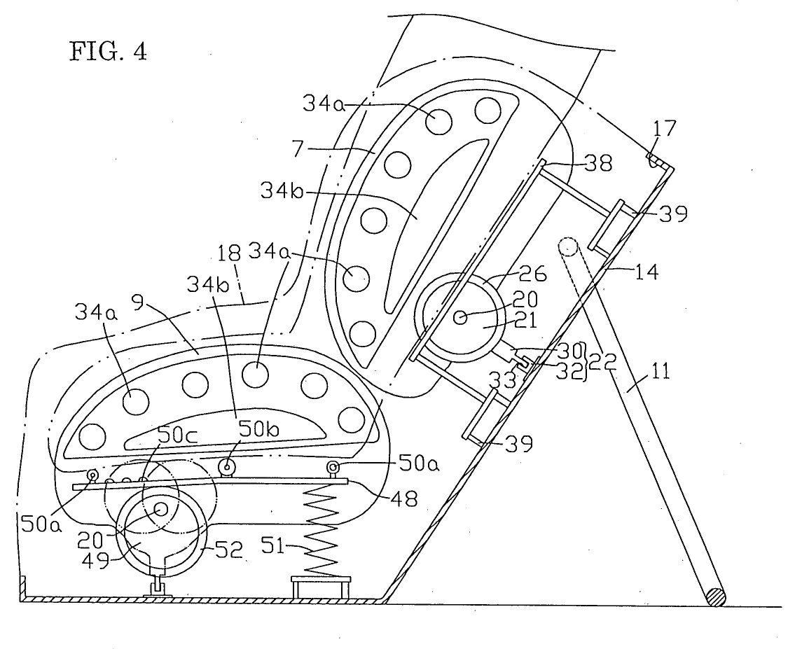

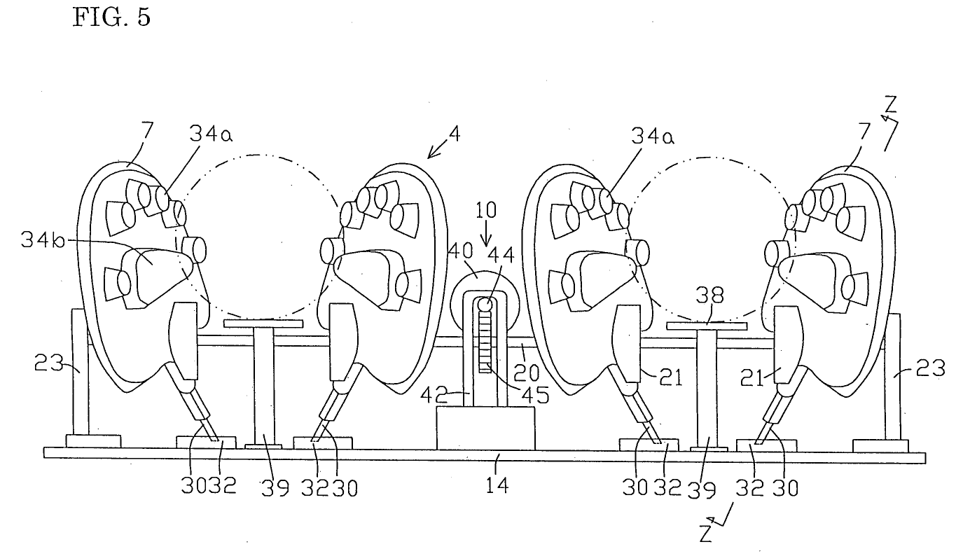

As shown in FIG. 1 to 6, the lower leg massager 1 comprises the leg-rest massaging mechanism 4 that is the first massaging mechanism, the footrest massaging mechanism 5 that is the second massaging mechanism, a driving mechanism 10 that drives both of the massaging mechanisms 4, 5.

This driving mechanism 10 and both of the massaging mechanisms 4, 5 are contained in a casing 13. This casing 13 consists of a supporting body 14 having an opened upper part and supporting the driving mechanism 10 and both of the massaging mechanisms 4, 5, and a lid body 15 covering the supporting body 14 from the upper side thereof.

The lid body 15 has opposing right and left side surfaces which are opened, and insertion recesses 6, 8 are formed in the leg-rest 2 and the footrest 3 by a coversheet 18 made of a highly elastic cloth, a leather, a sponge and like which covers opening portions 16 of the lid body 15 and an opening portion 17 of the supporting body 14.

As shown in FIG. 2 to 4, the supporting body 14 is substantially shaped in the form of a letter L in side view, and the leg-rest massaging mechanism 4 is disposed on the rear side of the supporting body 14, while the footrest massaging mechanism 5 is disposed on the front side of the supporting body 14.

A stand 11 is rotatably pivoted in an upper end portion of right and left sides of the lid body 15 for allowing the lower leg massager 1 to be placed on a surface such as a floor.

The leg-rest massaging mechanism 4 comprises the pair of right and left massaging members for calves 7, a rotation shaft 20 rotated by the driving mechanism 10, a rotary member 21 fixed to this rotation shaft 20 and relatively rotatably fitted in the massaging members for calves 7, and a restricting means 22 for restricting a following rotation of the massaging member for calves 7 with respect to this rotary member 21.

The rotation shaft 20 is rotatably supported by a supporting bracket 23 provided at both right and left ends of the supporting body 14. The rotary member 21 is provided at an intermediate portion of the rotation shaft 20 so as not to relatively rotate.

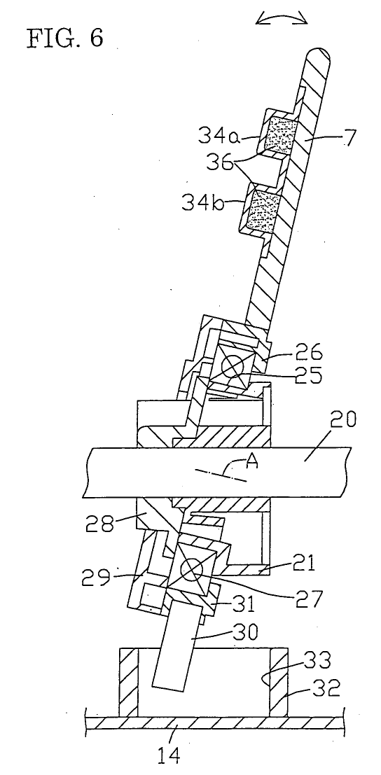

The rotary member 21 has a peripheral edge surface (sliding surface) which forms a substantially circular track 25 having an axis A inclined with respect to the rotation shaft 20, as shown in FIG. 6, and a boss portion 26 of the massaging member for calves 7 is relatively rotatably fitted to the rotary member 21 so as not to slide on this track 25.

Specifically, an inner race of a bearing 27 is fitted along the track 25 on an outer peripheral surface of a pair of right and left rotary members 21, and a fixing member 28 is provided on the outside of the rotary member 21 in the right and left direction for preventing dropping off of the bearing 27 and for fixing it.

An outer race of the bearing 27 is fitted to an inner peripheral surface of the ring shaped boss portion 26, and the massaging member for calves 7 is allowed to slide on the track 25 through the bearing 27.

Additionally, the right and left rotary members 21 are fixed to the rotation shaft 20 such that the incline directions of the tracks 25 of the rotary members 21 oppose with respect to each other. Further, a ring shaped holding member 29 is mounted on the outside surface of the boss portion 26 of the massaging member for calves 7 in the right and left direction for preventing dropping off of the bearing 27 and for fixing it.

An engaging member mounting portion 31 for mounting an engaging member 30 is integrally formed with the boss portion 26 substantially underneath the holding member 29, and the bar shaped engaging member 30 is fixed in such a manner as to project downward from the boss portion 26.

A restricting member 32 engaged by this engaging member 30 is provided on the supporting body 14 substantially underneath this engaging member 30. A sliding groove 33, in which the engaging member 30 is slidably fitted, is formed at the center of the restricting member 32 in a plan view. This sliding groove 33 extends in the right and left direction for guiding the massaging member for calves 7 in the right and left direction and is engaged with the engaging member 30 for restricting a rotation of the massaging member for calves 7 following the rotary member 21.

Therefore, the restricting means 22 comprises the engaging member 30 and the restricting member 32 having the sliding groove 33.

The massaging member for calves 7 comprises a long plate extending in a front and rear direction, which has a lower edge linearly extending in the front and rear direction, and a front edge, a rear edge, and un upper edge formed in rounded and curved configurations. This massaging member for calves 7 is constituted with a resilient body formed of plastics, a leaf spring or the like, which is resiliently deformable in the right and left direction or the direction of moving apart from the calf.

An affected part pushing body 35 comprising a plurality of affected part pushing portions 34a, 34b is provided on the opposing surfaces of the massaging members for calves 7. This affected part pushing body 35 is formed of an elastic material such as a rubber and comprises a plurality of pushing portions 34a formed as circular and small projections arranged along the upper edge of the massaging member for calves 7, and a larger pushing portion 34b formed in a long projection extending in the front and rear direction and provided below the pushing portions 34a.

As shown in FIG. 6, each of the pushing portions 34a, 34b has a hollow shape, and this inner hollow portion is filled with a cushion material 36 formed of such as a urethane foam resin to provide a moderate elasticity.

A pair of right and left leg mounts 38 for supporting lower sides of calves is provided at a substantially intermediate position between the pair of right and left massage members for calves 7 in the right and left direction. This leg mount 38 consists of a long board extending in the front and rear direction, and has front and rear ends fixed to a mounting base 39, so as to be fixed to the supporting body 14 through this mounting base 39.

The footrest massaging mechanism 5 comprises the massaging members for both sides of feet 9, a rotation shaft 20 rotated by the driving mechanism 10, a rotary member 21 fixed to this rotation shaft 20 and relatively rotatably fitted in the massaging members for both sides of feet 9, and a restricting means 22 for restricting a following rotation of the massaging member for both sides of feet 9 with respect to this rotary member 21.

Since the massaging members for both sides of feet 9, the rotation shaft 20, the rotary member 21, and the restricting means 22 of the footrest massaging mechanism 5 have the same constitutions as those in the footrest massaging mechanism 4, the explanations thereof are omitted by using the same reference numerals.

The driving mechanism 10 for driving both of the massaging mechanisms 4, 5 is disposed at a substantially intermediate position in the right and left direction and the front and rear direction.

This driving mechanism 10 comprises a single driving motor 40 that is rotatable in the forward and reverse direction, and a pair of front and rear power transmitting means 42 connected with front and rear ends of a driving shaft 41 of this driving motor 40 which is consisted by, for example, an electric motor.

The power transmitting means 42 are connected with the rotation shafts 20 of the massaging mechanisms 4, 5, respectively, and both of these power transmitting means 42 are fixed on intermediate portions of the supporting body 14 in the right and left direction (intermediate positions in the right and left direction with respect to the leg-rest 2 and also to the footrest 3).

The driving motor 40 is fixed on the intermediate portion of the supporting body 14 in the right and left direction through a motor mounting base 43 in the same way as the power transmitting means 42. The driving shaft 41 of the driving motor 40 extends in the front and rear direction (toward the rotation shafts 20 of both massaging mechanisms 4, 5) centering the driving motor 40 and connected with the power transmitting means 42. A worm gear 44 and a worm wheel 45 are incorporated in each of the power transmitting means 42 so as to transmit the rotation of the driving motor 40 to the rotation shaft 20.

More specifically, the worm gear 44 is provided on each of front and rear ends of the driving shaft 41 of the driving motor 40, and the worm gear 44 provided on the front end of the driving shaft 41 engages the worm wheel 45 fixed on the rotation shaft 20 of the footrest massaging mechanism 5, while the worm gear 44 provided on the rear end of the driving shaft 41 engages the worm wheel 45 fixed on the rotation shaft 20 of the leg-rest massaging mechanism 4.

Therefore, the rotation shafts 20 of both massaging mechanisms 4, 5 are caused to rotate simultaneously by making this driving motor 40 rotate.

Alternatively, power disconnectable clutches may be provided on the front side and the rear side of the driving shaft 41 of the driving motor 40, respectively, so that both massaging mechanisms 4, 5 are driven simultaneously or independently by the single driving motor 40, namely, the single driving mechanism 10 by operating the clutches.

A sole massaging mechanism 47 which is driven by the driving mechanism 10 for massaging a sole is provided on a position overlapping the massaging mechanism 5 of the footrest in the front and rear direction.

This sole massaging mechanism 47 comprises a sole massaging member 48 disposed between the pair of right and left massaging members for both sides of feet 9, the rotation shaft 20 rotated by the driving mechanism 10, a rotary member for a sole 49 fixed to this rotation shaft 20 and relatively rotatably fitted to the sole massaging member 48, and a supporting member 51 supporting this sole massaging member 48.

The massaging members for both sides of feet 9 is constituted with a resilient body formed of plastics, a leaf spring or the like, which deforms resiliently in a direction of moving apart from a foot in the right and left direction.

The rotary member for a sole 49 is formed in a substantially circular plate shape, and is eccentrically mounted on the rotation shaft 20 so as not to relatively rotate between the pair of right and left massaging member for both sides of feet 9.

More specifically, the rotary member for a sole 49 is fixed to the rotation shaft 20 in so as to decenter the center of the rotary member for a sole 49 to the up and down direction from the center of the rotation shaft 20 and is rotated together with the rotation shaft 20 integrally.

The sole massaging member 48 comprises a long plate extending in the front and rear direction for mounting a sole, an affected part pushing body 50a comprising small rollers and being disposed on front and rear portions of the upper surface of the sloe massaging member 48, and an affected part pushing body 50b comprising a large roller and being disposed at an intermediate position in the front and rear direction of the upper surface of the sole massaging member 48. Additionally, a plurality of affected part pushing bodies 50c comprising small projections are provided between the small roller 50a on the rear side and the large roller 50b. These affected part pushing bodies 50a, 50b, 50c perform acupressure with respect to a sole, and the affected part pushing bodies 50a, 50b among them comprising a large roller and small rollers are rotatable.

A supporting member 51 comprising a resiliently deformable coil spring is provided between the rear end of the sole massaging member 48 and the supporting body 14, so that the rear end of the sole massaging member 48 is movable in both of the front and rear direction and the up and down direction.

A boss portion 52 is provided on the front side of the sole massaging member 48, and the boss portion 52 is relatively rotatably fitted to the rotary member for a sole 49.

When the driving mechanism 10 is actuated, that is, when the driving motor 40 is rotated with the above constitution, the rotation shafts 20 of the both massaging mechanisms 4, 5 receive transmitted power and are rotated simultaneously, and the rotary members 21 of the both massaging mechanisms 4, 5 are rotated together with the rotation shaft 20.

Specifically in the leg-rest 2, the boss portion 26 of the massaging member for calves 7 of the leg-rest massaging mechanism 4 moves along the inclined track 25, and in the plan view (FIG. 2), for example, the boss portion 26 on right side sways in such a manner as to transit three positions of a left upward slanting position, a vertical position, and a right upward slanting position, in accordance with the rotation of the rotary member 21. The rotary member 21 on left side of the leg-rest massaging mechanism 4 also sways similarly in the symmetrical positions.

Therefore, the massaging member for calves 7 mounted in a projecting manner on the boss portion 26 moves in the same way, and swings like a seesaw in a manner that when one of their ends in the front and rear direction move toward each other, the other ends move away from each other, and when one of their ends move away from each other, the other ends move toward each other.

In the front view (FIG. 6), the boss portion 26 sways as mentioned above with respect to the rotation shaft 20, and in addition, the outer peripheral surface thereof also moves toward the axis. However, since the sliding groove 33 restricts the movement of the massaging member for calves 7 in such a manner as to sway in the right and left direction (not to rotate together with the rotary member 21), the massaging member for calves reciprocatingly swing toward and away from each other (reciprocating movement in the right and left direction) in the direction along the axis of the rotation shaft 20 (the right and left direction).

In combination of both of these, the massaging members for calves 7 are caused to perform swing motions (swelling motions) while moving toward and away from each other in the right and left direction.

The massaging members for both sides of feet of the footrest 3 also perform swing motions opposing to each other similarly to the massaging members for calves 7.

Additionally, the rotary member for a sole 49 is rotated by the rotation of the rotation shaft 20 of the footrest 3, and along with the rotation of the rotary member for a sole 49, the sole massaging member 48 reciprocatingly swing in the up and down direction about the supporting member 51 while moving in the front and rear direction.

As is evident from this, the leg-rest 2 and footrest 3 of the lower leg massager 1 are driven simultaneously by the single driving mechanism 10, and this allows simultaneous massaging of calves and both sides of feet. Moreover, since the sole massaging mechanisms 47 are also driven simultaneously, it is possible to massage soles at the same time.

Since the sole massaging members 48 swing in both the up and down direction and the front and rear direction, complicated massaging operations such as rubbing up and rubbing down with respect to the sole can be performed.

Further, since the driving mechanism 10 is disposed at the intermediate position in the right and left direction, a space in the intermediate portion in the right and left direction between the pairs of right and left insertion recesses 6, 8, in other words, a space in the intermediate portion in the right and left direction of the leg-rest 2 and the footrest 3 where calves or feet are not inserted, is effectively utilized, thereby allowing reduction of entire size of the apparatus.

Furthermore, since the single driving mechanism 10 drives both massaging mechanisms 4, 5, it is possible to reduce number of parts, thereby reducing entire size of the apparatus and reducing manufacturing costs.

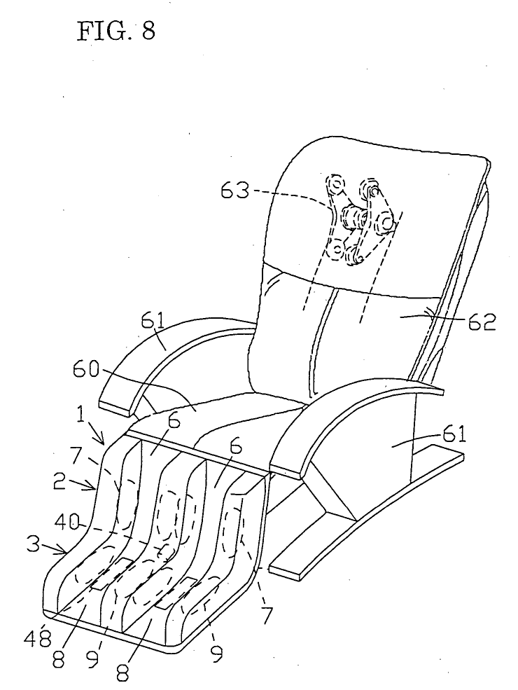

FIG. 8 shows an embodiment of a chair type massaging apparatus provided with the lower leg massager 1 described above.

The massaging apparatus shown in FIG. 8 is of a conventional chair type in which a seat is disposed at a higher position apart from a floor, and comprises a seat portion 60 for supporting a hip of a human body from below, a leg portion 61 supporting this seat potion 60, and a seatback portion 62 connected to a rear end portion of the seat portion.

A massaging mechanism for back 63 being capable of performing rubbing and tapping massage operations, is incorporated in the inside of the seatback portion 62 so as to be movable in an up and down direction, and a reclining mechanism (not shown) for changing an angle of inclination of the seatback portion 62 is provided in the inside of the seat potion 60.

The leg-rest 2 and the footrest 3 are connected to a front end of the seat portion 60.

A user is allowed to massage his/her calves and feet by means of the leg-rest 2 and the footrest 3 of the lower leg massager 1 disposed on the front portion of the seat portion 60, while massaging back and neck by means of the massaging mechanism for back 63 in the seatback portion 62 in a position of sitting on the seat portion 60.

Further, the lower leg massager 1 may be detachably connected with respect to the seat portion 28.

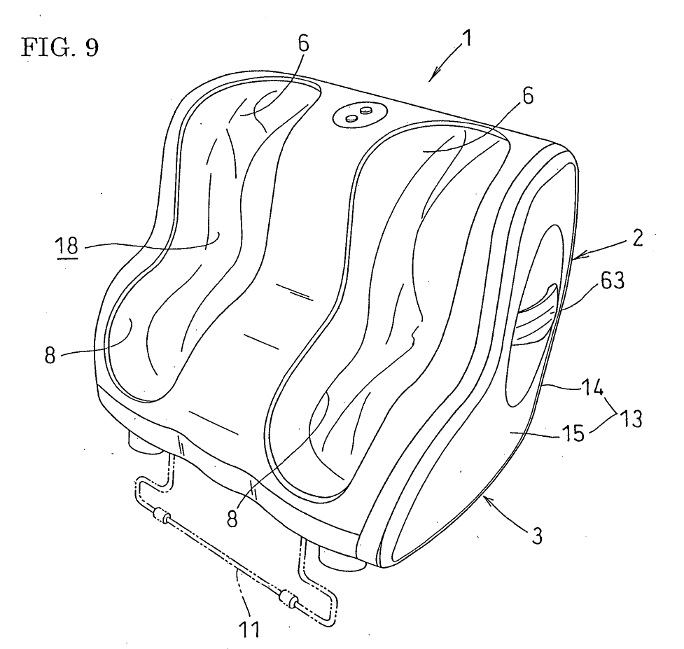

FIG. 9 to 12 show lower leg massagers 1 modified in view of design or the like such as to match the needs of consumers.

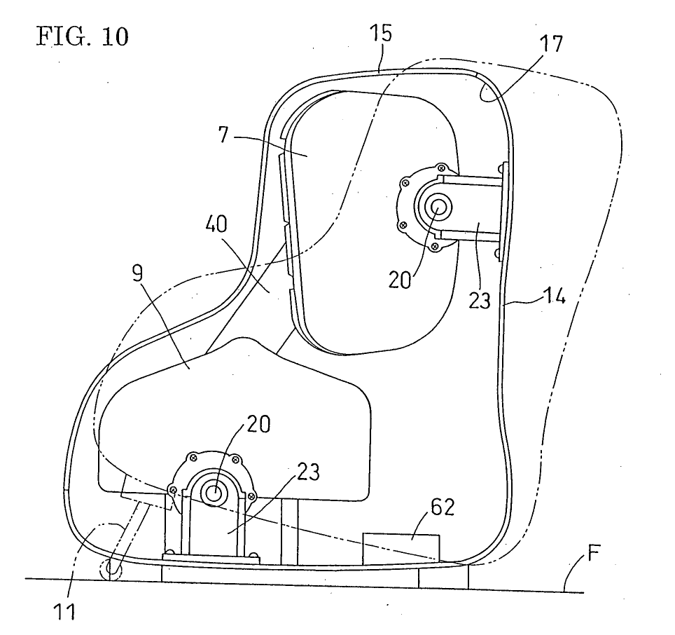

The stand 11 mentioned above is mounted on the front portion of the bottom surface of the casing 13 and is formed in a rectangle ring shape in front view. As shown with the two-dotted line in FIGS. 9 and 10, the casing 13 itself is reclined backward by placing the casing on the floor surface F with the stand 11 set to downwardly extend, whereby the insertion recess 6 for enclosing a calf is slightly rearwardly reclined. Additionally, since the front portion of the insertion recess 8 for enclosing a foot is raised, a user is allowed to massage lower legs comfortably in a position with the lower legs stretched out.

Handles 63 for carrying the lower leg massager 1 with both hands are formed on the both sides of the casing 13.

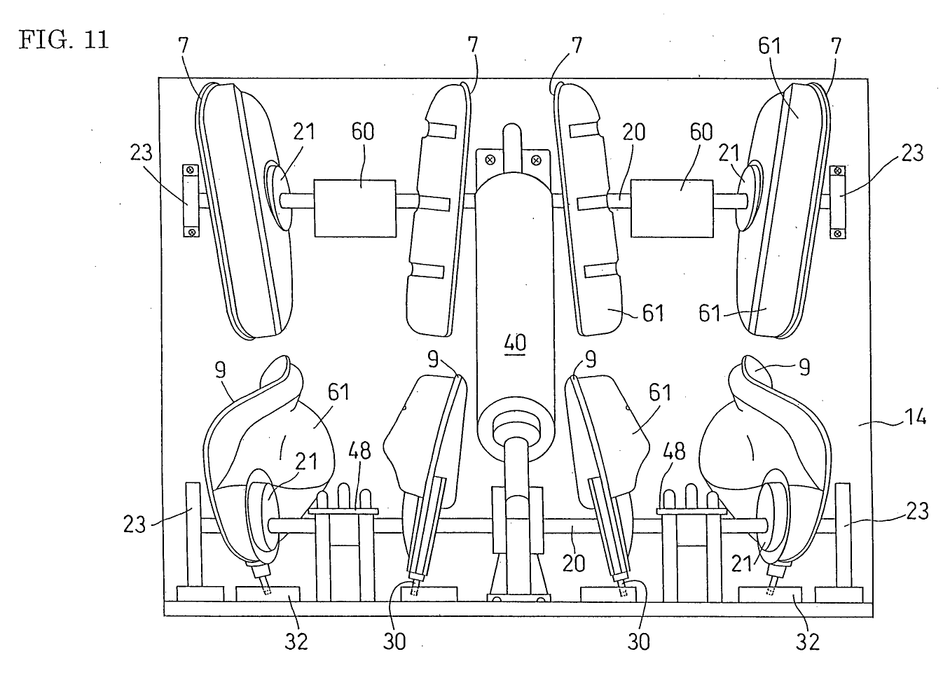

As shown in FIG. 11, a massaging roller 60 is provided, instead of the leg mount 38, at an intermediate position in the right and left direction between the pair of right and left massaging members for calves 7. This massaging roller 6 is eccentrically mounted on the rotation shaft 20 driving the massaging members for calves 7, so that the massaging rollers 60 reciprocate in the front and rear direction in accordance with the rotation of the rotation shaft 20 so as to push calves in the front and rear direction.

Further, the sole massaging members 48 are fixed to the supporting body 14.

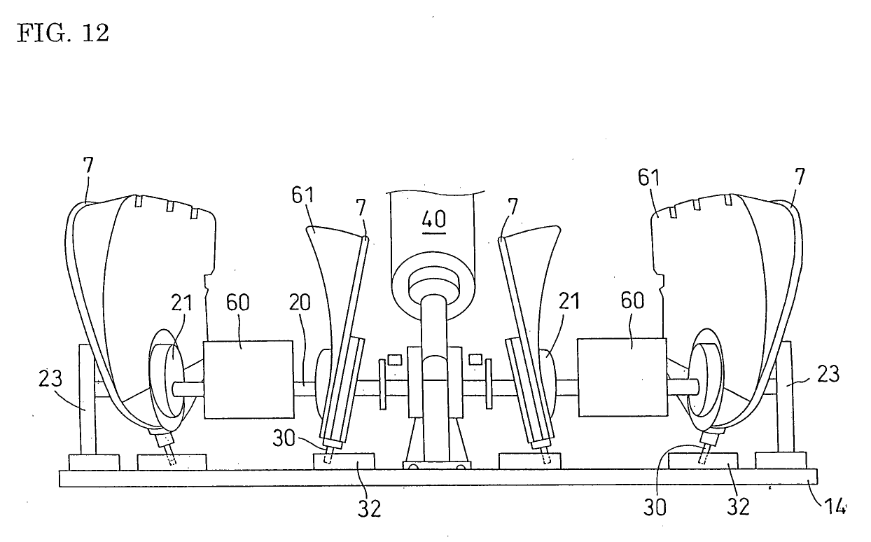

As shown in FIGS. 11 and 12, resilient bodies 61 having a shape to fit a calf and a foot are provided on the opposing sides of the massaging members for calves 7 and the massaging members for both sides of feet 9. With this arrangement, affected parts in calves, feet and the like are massaged in such a manner as to be enclosed by the massaging members 7, 7 or 9, 9.

The massaging members 7, 9 are driven by the driving motor 40, and the driving condition of this driving motor 40 is controlled by a controlling means 62 disposed at a lower part in the casing 13. A pulse signal is generated in the controlling means 62, and the driving motor 40 is driven in accordance with the pulse to vary rotating speed or the like. Since this controlling means 40 does not perform such as a phase control, it is possible to reduce number of electronic components constituting the controlling means 40 and to reduce occurrence of noises or the like to a minimum.

It should be noted that the lower leg massager according to the embodiments is not restricted to the above-mentioned embodiments. Although the single driving mechanism 10 drives both of the massaging mechanisms 4, 5 simultaneously according to the above-mentioned embodiments, two driving mechanisms 10 may be provided for driving the massaging mechanisms 4, 5 independently.

For example, two driving motors 40 may be provided at intermediate positions in the right and left direction of the leg-rest 2 and the footrest 3, respectively, so that the driving shafts 41 of each driving motor 40 are connected with each of the massaging mechanisms 4, 5 for independently transmitting power.

Alternatively, it is possible to provide the single driving mechanism 10, namely, the single driving motor 40 having driving shafts 41, 41 extending from front and rear sides thereof, and clutch mechanisms or the like (not shown) provided at intermediate positions of the driving shafts, respectively, for disconnecting or connecting the rotation of the driving shafts as necessary. With this arrangement, power can be transmitted to each of the massaging mechanisms 4, 5 independently so as to drive the mechanisms independently in accordance with user's needs.

Furthermore, though the leg-rest 2 and the footrest 3 are integrated, the present invention may comprise a leg-rest 2 and a footrest 3 which are separately formed. Further, the separately formed leg-rest 2 and footrest 3 may be arranged to be capable of varying an angle therebetween.

### INDUSTRIAL APPLICABILITY

The present invention can be applied to a massaging apparatus for massaging a lower leg, and can be used also as a massaging apparatus for massaging an upper leg.

1. A lower leg massager comprising:
a leg-rest comprising a first massaging mechanism disposed inside of the leg-rest and configured to receive and massage each calf of right and the left lower legs fitted therein;
a footrest disposed on an end of the leg-rest, and comprising a second massaging mechanism disposed in the footrest and configured to receive and massage each foot of the right and the left lower legs fitted therein; and
a driving mechanism disposed at an intermediate position in a right and left direction of the leg-rest and/or the footrest for simultaneously driving both the first massaging mechanism and the second massaging mechanism.

2. A lower leg massager comprising:
a leg-rest comprising a first massaging mechanism disposed inside of the leg-rest and configured to receive and massage each calf of right and the left lower legs fitted therein;
a footrest disposed on an end of the leg-rest, and comprising a second massaging mechanism disposed in the footrest and configured to receive and massage each foot of the right and the left lower legs fitted therein; and
a driving mechanism disposed at an intermediate position in a right and left direction of the leg-rest and/or the footrest for independently driving the first massaging mechanism and the second massaging mechanism.

3. A lower leg massager as set forth in claim 1, wherein the first massaging mechanism and the second massaging mechanism are driven by a single driving mechanism.

4. A lower leg massager as set forth in claim 3, wherein the driving mechanism comprises a single driving motor disposed between the first massaging mechanism and the second massaging mechanism, the driving motor having a driving shaft extending toward both of the massaging mechanisms and being connected therewith so as to transmit power.

5. A lower leg massager as set forth in claim 1, wherein a single supporting body supports the first massaging mechanism, the second massaging mechanism, and the driving mechanism.

6. A lower leg massager as set forth in claim 1, wherein the second massaging mechanism comprises a sole massaging mechanism driven by the driving mechanism for massaging a sole.

7. A lower leg massager as set forth in claim 1, wherein the first massaging mechanism comprises: a pair of massaging members disposed away from each other in the right and left direction so as to enclose the calf therebetween; a rotation shaft rotated by the driving mechanism; a rotary member fixed to the rotation shaft and relatively rotatably fitted in the massaging member; and a restricting means for restricting a following rotation of the massaging member with respect to the rotary member, the rotary member having a sliding surface formed in a cylindrical-shape tilting with respect to the rotation shaft so that the massaging member performs a swing motion.

8. A lower leg massager as set forth in claim 1, wherein the second massaging mechanism comprises: a pair of massaging members disposed away from each other in the right and left direction so as to enclose the foot therebetween; a rotation shaft rotated by the driving mechanism; a rotary member fixed to the rotation shaft and relatively rotatably fitted in the massaging member; and a restricting means for restricting a following rotation of the massaging member with respect to the rotary member, the rotary member having a sliding surface formed in a cylindrical-shape tilting with respect to the rotation shaft so that the massaging member performs a swing motion.

9. A lower leg massager as set forth in claim 7, wherein the leg-rest is formed with a pair of right and left insertion recesses into which calves are inserted, respectively, while the footrest is formed with a pair of right and left insertion recesses into which feet are inserted, respectively, and which are communicated with the insertion recesses of the leg-rest, respectively, and the pair of massaging members of the first massaging mechanism are disposed on the inside and on both right and left sides of each insertion recess of the leg-rest.

10. A lower leg massager as set forth in claim 9, wherein the massaging member comprises an elastic body which is elastically deformable in the right and left direction.

11. A lower leg massager as set forth in claim 8, wherein the leg-rest is formed with a pair of right and left insertion recesses into which calves are inserted, respectively, while the footrest is formed with a pair of right and left insertion recesses into which feet are inserted, respectively, and which are communicated with the insertion recesses of the leg-rest, respectively, and the pair of massaging members of the second massaging mechanism are disposed on the inside and on both right and left sides of each insertion recess of the footrest.

12. A lower leg massager as set forth in claim 11, wherein the massaging member comprises an elastic body which is elastically deformable in the right and left direction.

13. A lower leg massager as set forth in claim 1, wherein the leg-rest is formed with a pair of right and left insertion recesses into which calves are inserted, respectively, while the footrest is formed with a pair of right and left insertion recesses into which feet are inserted, respectively, and which are communicated with the insertion recesses of the leg-rest, respectively, and the driving mechanism is disposed in a space extending from a space between the pair of insertion recesses formed in the leg-rest to a space between the pair of insertion recesses formed in the footrest.

14. A lower leg massager as set forth in claim 4, wherein
the first massaging mechanism comprises: a pair of massaging members formed of an elastic body which is elastically deformable in the right and left direction and disposed away from each other in the right and left direction so as to enclose the calf therebetween; a rotation shaft disposed with an axis thereof oriented in the right and left direction; a rotary member fixed to the rotation shaft and relatively rotatably fitted in the massaging member; and a restricting means for restricting a following rotation of the massaging member with respect to the rotary member,
the second massaging mechanism comprises: a pair of massaging members formed of an elastic body which is elastically deformable in the right and left direction and disposed away from each other in the right and left direction so as to enclose the foot therebetween; a rotation shaft disposed with an axis thereof oriented in the right and left direction; a rotary member fixed to the rotation shaft and relatively rotatably fitted in the massaging member; and a restricting means for restricting a following rotation of the massaging member with respect to the rotary member,
the driving motor is provided at an intermediate position in the right and left direction and a front and rear direction of the first massaging mechanism and the second massaging mechanism, the driving motor having a pair of driving shafts extending in the front and rear direction centering the driving motor, the pair of driving shafts being connected to the rotation shafts of the massaging mechanisms, respectively, so as to be capable of rotating the rotation shafts.

15. A lower leg massager as set forth in claim 2, wherein the first massaging mechanism and the second massaging mechanism are driven by a single driving mechanism.

16. A lower leg massager as set forth in claim 2, wherein a single supporting body supports the first massaging mechanism, the second massaging mechanism, and the driving mechanism.

17. A lower leg massager as set forth in claim 2, wherein the second massaging mechanism comprises a sole massaging mechanism driven by the driving mechanism for massaging a sole.

18. A lower leg massager as set forth in claim 2, wherein the first massaging mechanism comprises: a pair of massaging members disposed away from each other in the right and left direction so as to enclose the calf therebetween; a rotation shaft rotated by the driving mechanism; a rotary member fixed to the rotation shaft and relatively rotatably fitted in the massaging member; and a restricting means for restricting a following rotation of the massaging member with respect to the rotary member, the rotary member having a sliding surface formed in a cylindrical-shape tilting with respect to the rotation shaft so that the massaging member performs a swing motion.

19. A lower leg massager as set forth in claim 2, wherein the second massaging mechanism comprises: a pair of massaging members disposed away from each other in the right and left direction so as to enclose the foot therebetween; a rotation shaft rotated by the driving mechanism; a rotary member fixed to the rotation shaft and relatively rotatably fitted in the massaging member; and a restricting means for restricting a following rotation of the massaging member with respect to the rotary member, the rotary member having a sliding surface formed in a cylindrical-shape tilting with respect to the rotation shaft so that the massaging member performs a swing motion.

20. A lower leg massager as set forth in claim 2, wherein the leg-rest is formed with a pair of right and left insertion recesses into which calves are inserted, respectively, while the footrest is formed with a pair of right and left insertion recesses into which feet are inserted, respectively, and which are communicated with the insertion recesses of the leg-rest, respectively, and the driving mechanism is disposed in a space extending from a space between the pair of insertion recesses formed in the leg-rest to a space between the pair of insertion recesses formed in the footrest.
